(19) United States
(12) Patent Application Publication
(10) Pub. No.: US 2006/0072910 A1
(43) Pub. Date: Apr. 6, 2006

(54) Video reproduction device and video reproduction method

(76) Inventor: Toshihiro Kato, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/113,027

(22) Filed: Apr. 25, 2005

(30) Foreign Application Priority Data
Oct. 6, 2004 (JP) 2004-293189

(51) Int. Cl. H04N 5/76

(52) U.S. Cl. 386/131; 386/46

(57) ABSTRACT

The following video reproduction device is provided that is intended so that when recorded video data is reproduced from a recording medium, videos not giving a feeling of discomfort to a user can be viewed by first acquiring display rate information processable by a display apparatus, then displaying the display rate information without conducting an unnecessary display rate conversion process, and reproducing the internal video data of the recording medium intact in an original format: The video reproduction device has an information acquisition unit for acquiring display rate information processable by the display apparatus, and during reproduction of internal video data from the recording medium, the information acquisition unit acquires the display rate information acquired within the display apparatus. Furthermore, a comparison is conducted between the acquired information and the display rate information contained in the recording medium, and if display rate conversion is unnecessary, the video data is output at the internal display rate of the recording medium.

### CLAIM OF PRIORITY

The present application claims priority from Japanese application serial no. P2004-293189, filed on Oct. 6, 2004, the content of which is hereby incorporated by reference into this application.

### BACKGROUND OF THE INVENTION

1. Field of the Invention

The present invention relates to a video reproduction device and video reproduction method for reproducing recorded video/audio data from recording media, and more particularly to an video reproduction device and video reproduction method that enables the display rates of video data to be converted.

2. Description of the Prior Art

With their commercialization as DVD discs in recent years, recorded movie contents are most commonly viewed in homes using a TV, a DVD player, or other audio-visual (AV) equipment. These movie contents are usually created in a 24-frame-per-second format. Prevailing TVs and other display apparatus, however, are equipment capable of making displays in the format of 30 frames (60 fields) per second. Therefore, movie contents that were created on a 24-frame-per-second basis must be converted into the 30-frame-per-second format before they can be reproduced on and output to currently available commercial DVD players. The conversion of these movie contents from the 24-frame-per-second format into the 30-frame-per-second format is called “2-3 pull-down”, which is employed in, for example, MPEG (Moving Picture Experts Group) standards.

Examples of such devices for converting video data of the 24-frame-per-second format include a device that uses a technique for converting video data from the 24-frame-per-second format into a 72-frame-per-second format and correspondingly converting the driving frequency of an external liquid-crystal display panel into a frequency appropriate for 72-frame-per-second reproduction. Such a device is described in, for example, Japanese Patent Laid-Open No. 2004-159191.

[Patent Reference 1]

Japanese Patent Laid-Open No. 2004-159191

### SUMMARY OF THE INVENTION

According to the above Patent Reference, before video data of the 24-frame-per-second format is reproduced, the video data is converted into the 72-frame-per-second format by processing in an video reproduction device. This video reproduction device is integrated with a display apparatus, and this display apparatus makes it possible to acquire the display rate of the video data to be actually displayed (hereinafter, this display rate is referred to as the actual display rate). Processing appropriate for the actual display rate is possible for that reason.

When the display apparatus is provided as an external one, even if a display rate processable by the external display apparatus can be acquired, it is customary that the actual display rate cannot be acquired. Therefore, even when a conversion into a display rate processable by the external display apparatus is conducted in the video reproduction device, the need arises for the external display apparatus to conduct a further conversion into the actual display rate. Video quality is deteriorated by such double conversion of the original display rate (first with the video reproduction device and then with the external display apparatus).

An object of the present invention, therefore, is to provide an video reproduction device and video reproduction method that solves the above problem.

In order to achieve the above object, an video reproduction device and video reproduction method according to the present invention controls a display rate converter so as not to convert a display rate of video data when the display rate is included in display rates processable by an external display apparatus which acquired the display rates via a communications unit.

Also, in a first embodiment, display rates processable by an external display apparatus are characterized in that the display rates differ from ones processable for display by the external display apparatus. The display rates processable for display by the external display apparatus are display rates at which the external display apparatus can actually display video data. The display rates processable by the external display apparatus make video data actually displayable on the display apparatus, by being converted into appropriate display rates by a display rate converter built into the external display apparatus.

The present invention makes it possible to provide an video reproduction device and video reproduction method that has improved in the ease of use.

### BRIEF DESCRIPTION OF THE DRAWINGS

FIG. 1 is a block diagram showing an embodiment of a reproduction unit in an video reproduction device of the present invention;

FIG. 2 is a conventional example showing a display apparatus which displays the video data transmitted from an video reproduction device;

FIG. 3 is a conventional example showing a method of converting a display rate; and

FIG. 4 is an example of a flowchart showing a process flow of an video reproduction method according to the present invention.

### DESCRIPTION OF THE PREFERRED EMBODIMENTS

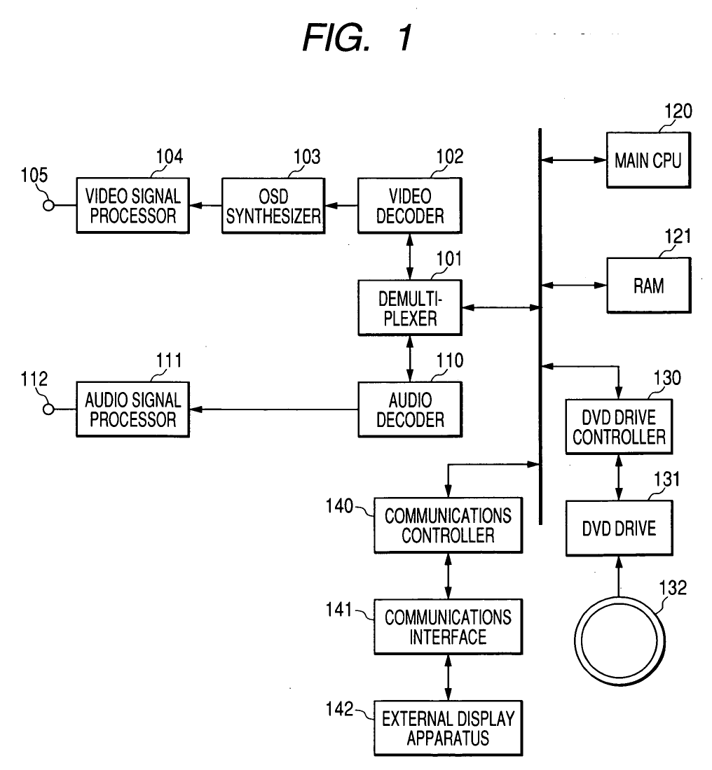

Examples of a DVD player, as embodiments of an video reproduction device according to the present invention, will be described hereunder with reference to the accompanying drawings. First, description is given of a method for reading out and reproducing video/audio/graphic data from a recording medium. FIG. 1 is a block diagram showing an embodiment of a DVD player. Video/audio data that has been read out from a DVD disc 132 by a reproduction head such as an optical pickup is separated and converted into digitally encoded video data and digitally encoded audio data by a demultiplexer 101. The type of reproduction head is not specifically limited and it needs only to be able to reproduce data from the recording medium. The reproduction head is, for example: an optical pickup for an optical disc such as a DVD; a magnetic head for a magnetic recording medium such as an HDD; or a signal-processing circuit for a semiconductor recording medium such as a memory card.

For video data, an video decoder 102 decodes digitally encoded video data, an OSD synthesizer 103 synthesizes graphic data and decoded video data in accordance with an instruction from a main CPU 120, and an video signal processor 104 converts the video data output from the OSD synthesizer 103, into a format such as NTSC, and then outputs the data to an external video display apparatus (for example, a TV) via an video output terminal 105. Instructions from the main CPU 120 to the OSD synthesizer 103 include the graphics display instructions given by a user. These instructions are executed, for example, to display the menus and others that the reproduction device has, and to display graphics in accordance with the graphics display instructions recorded on the recording medium during reproduction.

For audio data, an audio decoder 110 decodes digitally encoded audio data, an audio signal processor 111 converts the audio data decoded by the audio decoder 110, into analog audio signals by DA conversion, then amplifies the analog audio signals, and outputs the signals to an external output device (for example, a speaker) via an audio output terminal 112.

For conversion and output of the video data display rates pre-recorded on the recording medium, the main CPU 120 controls a DVD driver controller 130 and reads out the display rate information pre-recorded on the recording medium. Furthermore, after judging it necessary, from the display rate information that has been read out above, to convert either of the display rates, the main CPU 120 controls the video decoder 102 and sends an instruction to convert that display rate into a desired one. The video decoder 102 converts the particular display rate of the decoded video data into the desired one in accordance with the instruction from the main CPU 102, and then transmits the converted display rate to the OSD synthesizer 103. That is to say, the video decoder 102 functions as a display rate converter that converts display rates.

A method of converting the foregoing display rate is described next. FIG. 3 shows an example of a method of display rate conversion by the video reproduction device. In FIG. 3, the video data display rate before being converted is shown as, for example, 24 p to denote 24 frames/second, and the video data display rate after being converted is shown as 60i to denote 30 frames/second (60 fields/second).

In the figure, one pre-conversion frame is converted into two or three post-conversion fields. In this method, a converted video (one frame) is constructed of different frames (third and fourth frames of the converted video data in FIG. 3). This conversion method is a method commonly used. However, sine the converted video data is produced from different frames, the video is of an indistinct profile, thus giving a feeling of discomfort.

The video reproduction device uses the above-described method to reproduce recorded video/audio data from the recording medium.

Next, description is given of an external display apparatus that receives and displays the video data reproduced by the video reproduction unit.

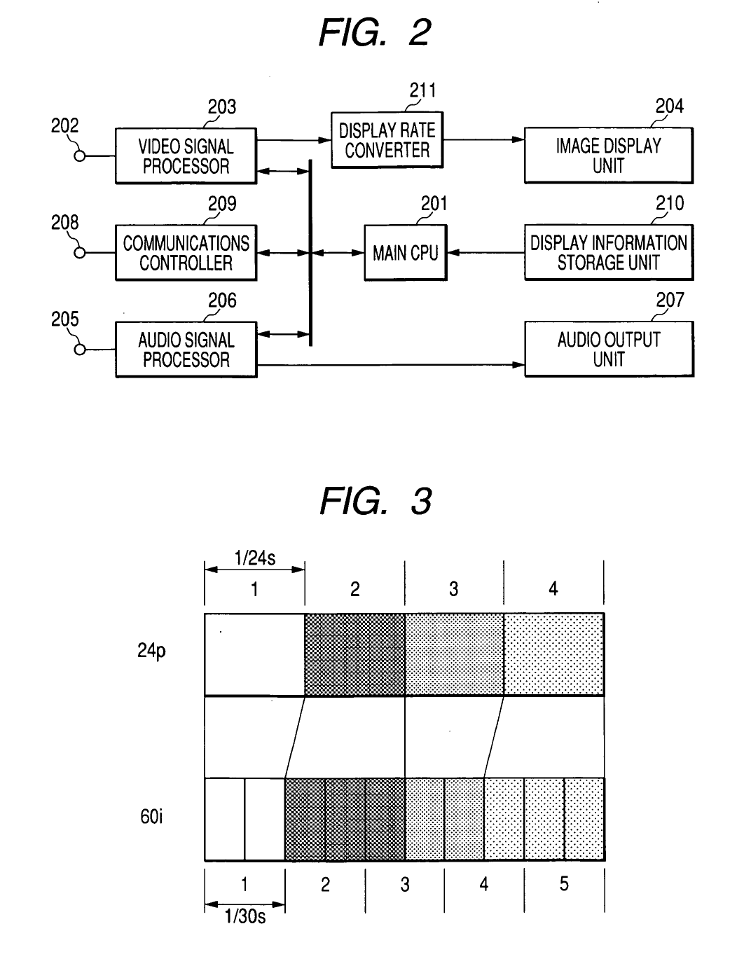

FIG. 2 is a block diagram showing an embodiment of the external display apparatus, for example, a TV. Also, this figure shows an equivalent of the external display apparatus 142 shown in FIG. 1.

Video data that has been input from an video input terminal 202 is transmitted to an video display unit 204 via an video signal processor 203 and a display rate converter 211, and displayed. If a display rate of the input video data differs from a display rate processable within the video display unit 204, the display rate converter 211 converts the display rate of the video data into a display-enabling display rate. In the display rate converter 211, however, not all display rates can be converted into ones processable within the video display unit 204, and processable display rates have their limits. The video display unit 204 is equivalent to, for example, a cathode-ray-tube display, a liquid-crystal panel, or the like. Audio data that has been input from an audio input terminal 205 is transmitted to an audio output unit 207 via an audio signal processor 206, and output. The audio output unit 207 is equivalent to, for example, a speaker. The video signal processor 203 and the audio signal processor 206 perform processes (such as A/D conversion and noise reduction) on input video/audio data. An arrangement form of the display rate converter 211 and video signal processor 203 may be reversed with respect to the arrangement shown in FIG. 2.

Input video data is output to the external display apparatus by use of the method described above.

A method of acquiring display rate information processable by the external display apparatus, and displaying video data at a desired display rate, is described next. Even if actual display rates are, for example, 50 p and 60i or other display rates (for example, 24 p), the external display apparatus can process these display rates by converting each. Since processable display rates are limited, however, the video reproduction device is adapted to acquire the above display rate information from the external display apparatus as display rate information processable by the external display apparatus.

When the video data recorded on the recording medium is to be reproduced using the above method, the main CPU 120 first transmits a communications controller 140 to acquire display rates processable by an external display apparatus 142. Next, in accordance with the instruction from the main CPU 120, the communications controller 140 controls a communications interface (I/F) 141 and sends an instruction to the external display apparatus to transmit display rates processable by the external display apparatus. The main CPU 201 in the external display apparatus which has received the above instruction reads out processable display rates from a display information storage unit 210 and transmits the display rate information from a data communications terminal 208 via a communications controller 209 to the video reproduction device.

The main CPU 120 uses the received display rate information to confirm whether the video data recorded on the recording medium is processable at the display rate of the recorded video data. If the video data is not processable at this display rate, the main CPU converts the display rate by use of the above method and then outputs the above-converted video data to the external display apparatus. Conversely, if the video data recorded on the recording medium is processable at the display rate of the recorded video data, the main CPU controls the video decoder 102 and sends an instruction thereto so as not to convert the display rate of the video data. The video decoder 102 that has received the instruction does not convert the display rate of the video data after decoding it, and transmits the video data to the OSD synthesizer 103. Subsequently, the video data is transmitted to the external display apparatus by use of the method described above.

During the acquisition of the display rates processable by the external display apparatus in the present invention, similar advantageous effects can be obtained, irrespective of whether the form used for connection between the video reproduction device and the external display apparatus is wireless.

Use of the above-described method makes it possible for the video reproduction device, when reproducing the video data pre-recorded on the recording medium, to acquire display rate information processable by an external display apparatus. Also, if a display rate of the video data reproduced is included in display rates processable by the external display apparatus, the video reproduction device can output the video data to the external display apparatus without converting the display rate. Accordingly, it is possible to display videos not giving a feeling of discomfort.

Next, description is given of a process flow during which all process steps from acquiring display rate information of the video data recorded on the recording medium, to sending the information to the external display apparatus, are implemented on a software basis using the above-described method.

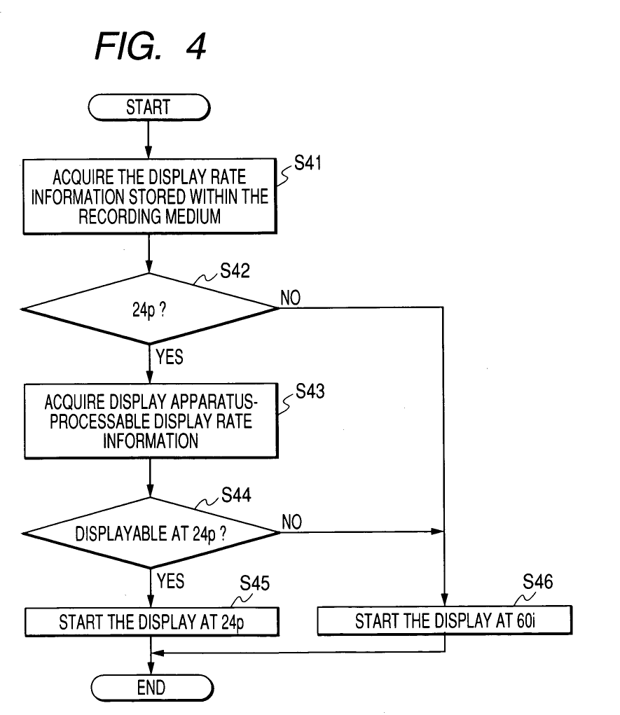

FIG. 4 shows an example of the above process flow. The present invention assumes that the video data recorded on the recording medium is 24 frames/second (24 p) in display rate and that each display rate processable by the external display apparatus is 30 frames/second (60i).

After receiving an video data reproduction instruction from a user, the video reproduction device reads out in step 41 the display rate of the video data recorded on the recording medium, and in step 42, identifies whether the display rate is 24 p. If the display rate is 24 p, the video reproduction device operates in step 43 to communicate with the external display apparatus and acquire display rate information processable by the external display apparatus. Next, the video reproduction device identifies whether the display rate information that it has acquired as the display rates processable by the external display apparatus includes a display rate of 24 p. If a display rate of 24 p is included, the video reproduction device judges in steps 44 that output to the external display apparatus at 24 p is possible. If display at 24 p is possible, the video reproduction device transmits decoded video data to the external display apparatus in step 45 without performing a display rate conversion on the video data. If, in step 42, the display rate of the video data recorded on the recording medium is judged not to be 24 p, the video reproduction device outputs the video data at a display rate of 60i. If, in step 44, processing at 24 p by the external display apparatus is judged to be impossible, the video reproduction device operates in step 46 to convert the decoded video data into a 60i format and output the video data.

As described above, for example, if the external display apparatus such as a TV is applicable to 24 p, the movie contents (or others) that were recorded on DVD discs can be displayed without conducting unnecessary display rate conversions during reproduction from the discs. Consequently, videos not giving a feeling of discomfort can be provided to the user.

The present embodiment is applicable, even if the external display apparatus does not have the display rate converter 211. The embodiment is particularly effect when a display rate of the video data recorded on the recording medium 132 is 24 frames/second and this display rate is included in the display rates that enable display on the external display apparatus. This rate of 24 frames/second is a frame rate used during creation of movies. Although current TVs are not adapted to display video data or other data directly at this frame rate, if the TVs are able to make such direct displays at the particular frame rate, the user can view video data as if the user were actually watching a movie.

According to the present embodiment, display rate information to be processed using an external display apparatus is acquired prior to reproduction. Therefore, if a display rate of video data to be reproduced is that processable by the external display apparatus, the video data recorded on the recording medium can be output without converting the display rate, and it thus becomes possible to display videos not giving a feeling of discomfort to the user. In addition, the display rate is converted as necessary. This makes it possible to avoid unnecessary display rate conversion and hence to remove redundancy of processing. Furthermore, it is possible to prevent deterioration of video quality due to unnecessary display rate conversion.

While an video reproduction device and video reproduction method relating to display rate conversion has heretofore been described as an embodiment, the present invention is not limited to this embodiment and is applicable even to an example in which the “display rate(s)” are rewritten to mean the “number of pixels”. Even in this example, unnecessary conversion of the number of pixels can be prevented and the redundancy of unnecessary processing and the deterioration of video quality due to unnecessary processing are avoidable. Furthermore, it goes without saying that an example allowing for both the “display rate(s)” and the “number of pixels” is one embodiment of the present invention.

Besides, while the above embodiments relate to the video data recorded on the recording medium, the present invention is not limited to these embodiments. These embodiments may, of course, relate to the video data received via the Internet, or the video data transmitted from broadcasting stations.

What is claimed is:

1. An video reproduction device, comprising:
a display rate converter that converts a display rate of video data;
a communications unit that communicates with an external display apparatus; and
a controller that, when the display rate of the video data is included in display rates processable by the external display apparatus which acquired the display rates via said communications unit, controls said display rate converter so as not to convert the display rate of the video data.

2. The video reproduction device according to claim 1, wherein:
the display rates processable by the external display apparatus differ from the display rates that enable display on the external display apparatus.

3. The video reproduction device according to claim 2, wherein:
each of the processable display rates is 24 frames/second, and each of the display-enabling display rates is 30 frames/second.

4. The video reproduction device according to claim 1, wherein:
when the display rate of the video data is not included in display rates processable by the external display apparatus which acquired the display rates, said controller controls said display rate converter so as to convert the display rate into a predetermined display rate.

5. The video reproduction device according to claim 1, wherein:
when the external display apparatus cannot acquire processable display rates via said communications unit, said controller controls said display rate converter so as to convert the display rate into a predetermined display rate.

6. The video reproduction device according to claim 1, wherein:
a display rate predetermined in said display rate converter is 24 frames/second.

7. The video reproduction device according to claim 1, wherein:
the video data and the display rate thereof are already recorded on a recording medium.

8. The video reproduction device according to claim 1, wherein:
the video data and the display rate thereof are already transmitted from a broadcasting station.

9. The video reproduction device according to claim 1, wherein:
the video data and the display rate thereof are already received via the Internet.

10. The video reproduction device according to claim 1, wherein:
the display rate of the video data is a first display rate; and
either of the display rates processable by the external display apparatus which acquired the display rates via said communications unit is a second display rate greater than the first display rate.

11. An video reproduction device, comprising:
a display pixel quantity converter that converts the number of display pixels contained in video data;
a communications unit that communicates with an external display apparatus; and
a controller that, when the number of display pixels in the video data is included in display pixel quantities processable by the external display apparatus which acquired the display pixel quantities via said communications unit, controls said display pixel quantity converter so as not to convert the number of display pixels contained in the video data.

12. An video reproduction method, comprising:
acquiring a display rate of video data;
acquiring display rates processable for an external display apparatus to make displays; and
when the display rate of the video data is included in display rates processable by the external display apparatus, transmitting the video data to the external display apparatus without converting the display rate of the video data.
